(19) United States
(12) Patent Application Publication
(10) Pub. No.: US 2015/0132611 A1
(43) Pub. Date: May 14, 2015

(54) Thermal Management And Connection Device For A Battery Module

(71) Applicant: Valeo Systemes Thermiques, Le Mesnil Saint Denis (FR)

(72) Inventors: Vincent Feuillard, Le Mesnil St. Denis (FR); Gilles Elliot, Courcouronnes (FR); Karen Chauvin, Le Pecq (FR); Friedbald Kiel, Fontainebleau (FR)

(21) Appl. No.: 14/400,892

(22) PCT Filed: May 3, 2013
(86) PCT No.: PCT/EP2013/059226

§ 371 Date: Nov. 13, 2014

(30) Foreign Application Priority Data
May 14, 2012 (FR) 1201391

(51) Int. Cl. H01M 10/42; H01M 2/20; H01M 10/63; H01M 10/6556; H01M 10/625

(52) U.S. Cl. CPC H01M 10/425; H01M 10/5057; H01M 10/5016; H01M 10/502; H01M 10/4207; H01M 2/206; H01M 2010/4271; H01M 2220/20
USPC 429/7

(57) ABSTRACT

The present invention concerns a thermal management and connection device for a battery module (1) consisting of cells (3) juxtaposed in parallel and connected to each other in series, each cell (3) comprising a positive terminal (4) and a negative terminal (4), said battery module (1) further comprising a heat exchange plate (10) comprising an inlet (12A) and an outlet (12B) for a heat-transfer fluid, positioned between the terminals (4), and a non-conductive connection plate (20) comprising holes (22) for the passage of the terminals (4) and means (6) for connecting said terminals (4) two by two with each other, the connection plate (20) being a printed circuit comprising conductor tracks (60).

The present invention relates to the connection, management, control and thermal regulation of batteries and, more particularly, a thermal management and connection device for a battery module in the field of electric and hybrid vehicles.

The management, electronic control and thermal regulation of batteries, notably in the field of electric and hybrid vehicles, are important issues. Specifically, from a thermal regulation viewpoint, if the batteries are subjected to excessively cold temperatures, their autonomy may decrease sharply and if they are subjected to excessively high temperatures there is a risk of thermal runaway which may go so far as to destroy the battery.

As far as the electronic control and management of batteries is concerned, this is important, notably in order to manage the charging and discharging of these batteries and control the physical and electric parameters so as to improve the autonomy and the durability of the batteries.

In electric and hybrid vehicles, the batteries are generally in the form of cells juxtaposed parallel to one another in a protective casing and what is referred to as a battery module. The cells may be juxtaposed in such a way that the positive and negative terminals of each cell alternate so that said cells can be connected in series with one another easily. It is also known for the cells to be juxtaposed with the terminals of like pole positioned on one and the same side of the battery module.

In order to regulate the temperature of the cells it is known practice to add a device that regulates the temperature of the battery module. Such a device is generally incorporated into a housing containing one or more battery modules and uses heat-transfer fluids circulating, for example pumped, through a circuit of ducts, said circuit of ducts notably passing under or inside a heat-exchange plate in direct contact with the cells.

The heat-transfer fluids can thus absorb heat emitted by the cells in order to cool them and remove this heat at one or more heat exchangers such as, for example, a heater or a cooler. The heat-transfer fluids may also, if need be, supply heat in order to warm said cells, for example if they are connected to an electrical resistance or to a positive temperature coefficient (PTC) heater.

The heat-transfer fluids generally used are the ambient air or liquids such as water or a solution of water and glycol for example. As liquids are better conductors of heat than gases, they are a solution which is favored because of its greater effectiveness.

In general, the heat-exchange plates in direct contact with the cells are placed in the bottoms of the housings containing one or more battery modules, said battery modules resting on said heat-exchange plates. Another known option is to position the heat-exchange plates between the cells. However, such locations of heat-exchange plates are not optimal because the regions of greatest heating of battery modules are situated between the terminals of the cells. In order to address this problem, one solution is to position the heat-exchange plate between the terminals of the battery module and to hold it in position using a retaining plate.

In order to provide control of the battery modules, the latter are generally connected to electronic control devices, more particularly to printed circuits intended to control physical and electrical parameters such as the temperature and voltage thereof. These data are then sent to and processed by a processing unit which can then influence these parameters in order to improve the autonomy and durability of the battery modules by regulating the temperature thereof via the heat-exchange plate and protecting them against overcharging and excessively deep discharge.

It is crucial to incorporate equipment providing control and thermal regulation of the battery modules within an electric or hybrid vehicle, although this entails the use, within the vehicle, of space that could be more usefully employed for incorporating additional batteries for example. In addition, the incorporation of such equipment makes the vehicle heavier, thereby reducing its autonomy.

One of the objects of the invention is therefore to overcome at least partially the disadvantages of the prior art and propose an optimized battery module with its control and management equipment.

The present invention therefore relates to a thermal management and connection device for a battery module composed of cells which are juxtaposed in parallel and connected in series with one another, each cell comprising a positive terminal and a negative terminal, said battery module further comprising a heat-exchange plate comprising an inlet and an outlet for heat-transfer fluid, these being positioned between the terminals, and a non-conducting connection plate comprising passage orifices for the terminals and means of connecting said terminals together in pairs, the connection plate being a printed circuit comprising conducting traces.

According to one aspect of the invention, the connection plate further comprises electronic devices for controlling the cells, said electronic devices being connected to the conducting traces.

According to another aspect of the invention, the means of connecting the terminals are positioned in such a way as to allow said terminals to be connected when the cells are juxtaposed with the terminals of an identical pole which are arranged on one and the same side of the battery module.

According to another aspect of the invention, the means of connecting the terminals are positioned so as to allow said terminals to be connected when the cells are juxtaposed with the terminals of a different pole which are arranged in a staggered configuration on the battery module.

According to another aspect of the invention, the connection means are positioned on the external surface of the connection plate, namely on the surface thereof that is the opposite surface to the surface facing the battery module.

According to another aspect of the invention, the connection means are produced integrally with the conducting traces, of increased thickness, of the connection plate.

According to another aspect of the invention, the connection means are positioned within the thickness of the connection plate.

According to another aspect of the invention, the connection means have a thickness less than the thickness of the connection plate.

According to another aspect of the invention, the connection means have a thickness equal to or greater than the connection plate.

According to another aspect of the invention, the connection plate is made of a rigid material.

According to another aspect of the invention, the connection plate is made of a flexible material.

According to another aspect of the invention, the heat-exchange plate is independent of the connection plate.

According to another aspect of the invention, the heat-exchange plate is incorporated directly into the connection plate.

According to another aspect of the invention, the connection plate comprises separating ribs electrically insulating the heat-exchange plate and the connection means.

Further features and advantages of the invention will become more clearly apparent from reading the following description given by way of nonlimiting illustration and from studying the attached drawings in which:

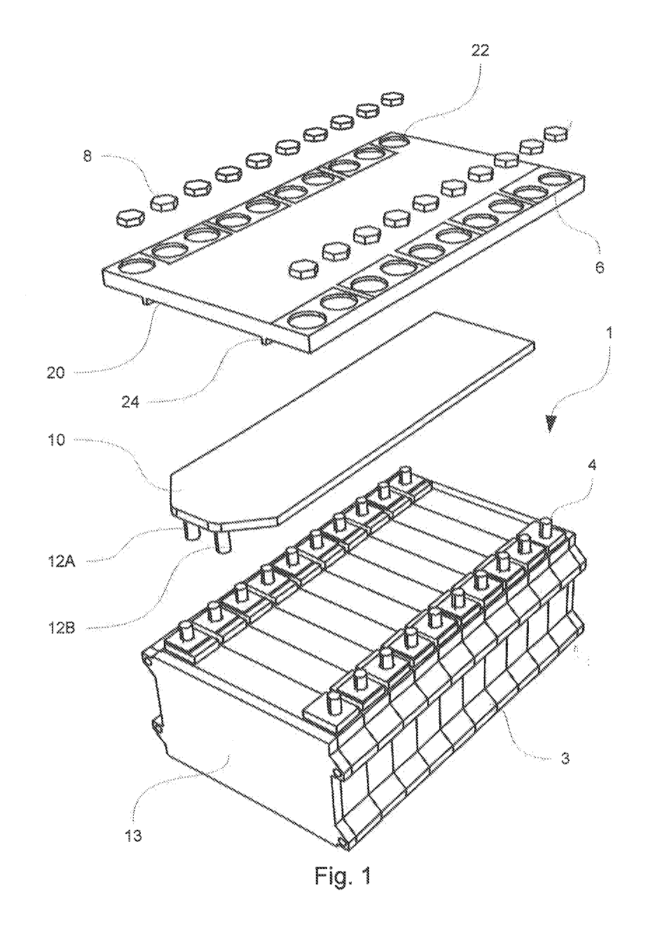

FIG. 1 is a schematic depiction in exploded perspective of a thermal management and connection device for a battery module according to one embodiment,

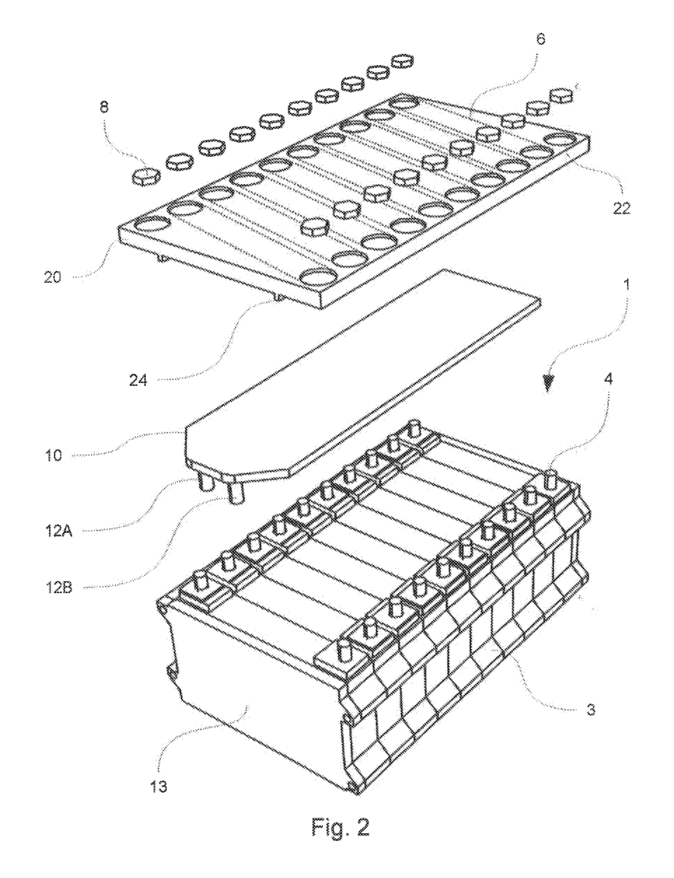

FIG. 2 is a schematic depiction in exploded perspective of a thermal management and connection device for a battery module according to another embodiment,

FIG. 3 is a schematic depiction in cross section of a thermal management and connection device positioned on a battery module,

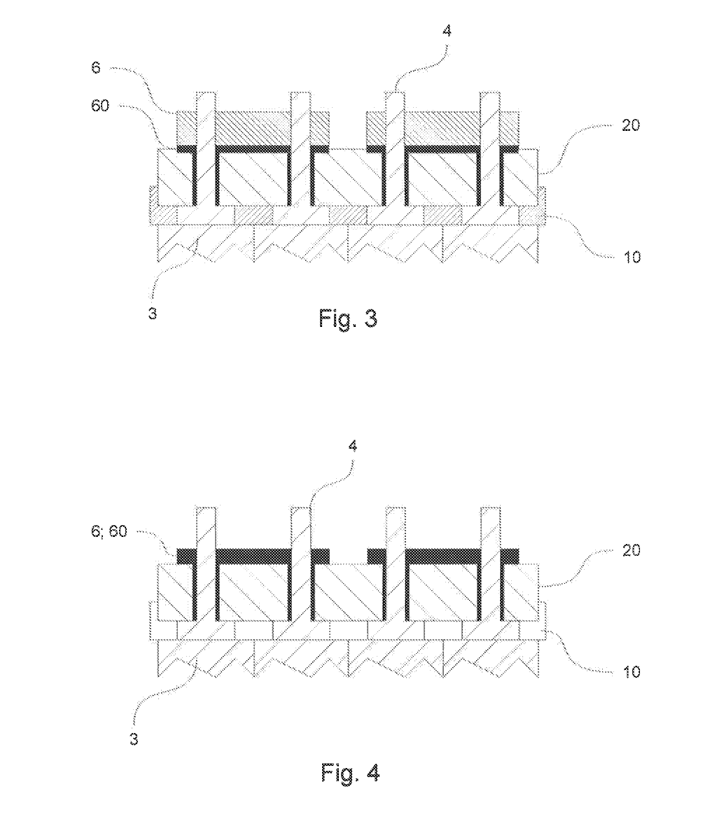

FIG. 4 is a schematic depiction in cross section of a thermal management and connection device positioned on a battery module according to a first alternative embodiment,

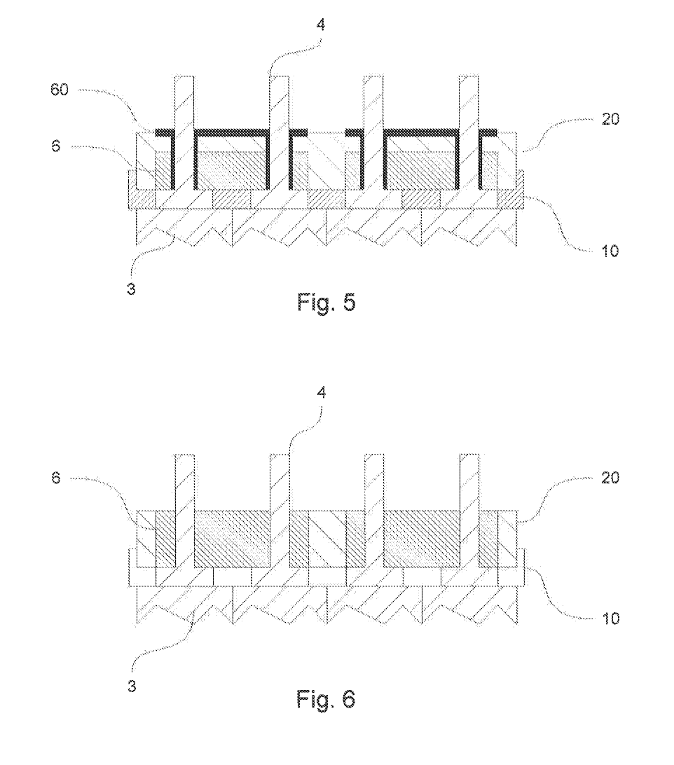

FIG. 5 is a schematic depiction in cross section of a thermal management and connection device positioned on a battery module, according to a second alternative embodiment,

FIG. 6 is a schematic depiction in cross section of a thermal management and connection device positioned on a battery module, according to a third alternative embodiment.

In the various figures, elements which are identical bear the same reference numerals.

FIGS. 1 and 2 show exploded perspective views of a battery module 1 and of its thermal management and connection device. The battery module 1 thus comprises cells 3 juxtaposed parallel to one another. Each cell 3 comprises terminals 4, one positive terminal and one negative terminal. In these FIGS. 1 and 2, the cells 3 are positioned in such a way that their terminals are aligned, forming two aligned series of terminals 4.

In order to differentiate between the positive and negative terminals of one and the same cell 3 and thus avoid connection errors, it is possible to have terminals 4 of different diameters. Thus, for example, the negative terminals of each cell 3 have a larger diameter than the positive terminals, or vice versa.

In order to hold the various cells 3 together, it is possible for said cells 3 to be clamped between two end plates 13 which are connected by through-bolts.

In order to connect the various cells 3 together in series by electrically connecting the positive terminal of one cell 3 to the negative terminal of one of the adjacent cells 3, the thermal management and connection device comprises a connection plate 20 which is not conducting but comprises means 6 of connecting the terminals 4 together, and orifices 22 through which the terminals 4 pass. The connection plate 20 is placed on the battery module 1 and held in place by means of fixing elements 8, such as nuts which are screwed onto the terminals 4.

The fact that the connection means 6 are present directly on the connection plate 20 notably allows for more rapid wiring of the battery module 1. In addition, it is possible to incorporate a connection poka-yoke system directly into the connection plate 20, for example by using positive and negative terminals of different diameters with orifices 22 of corresponding diameter. The connection means 6 are generally components made of metal, more particularly of copper, the thickness of which is sufficient to withstand and effectively conduct the current between two terminals 4. The connection means 6 may be etched into the connection plate 20, attached to the latter or even produced in the form of copper inserts, using various methods known to those skilled in the art. In the latter instance, the copper inserts are preferably not clamped directly onto the material of the connection plate 20 but onto some copper attached thereto.

The connection plate 20 is preferably a printed circuit comprising conducting traces 60, for example made of copper, likewise connecting the positive and negative terminals of the cells 3. In an alternative form, the connection plate 20 may be made of a rigid material to make it easier to fit and to make the battery module 1 more rigid. According to another alternative form, the connection plate 20 may on the other hand be made of a flexible or semi-flexible material in order to make the battery module 1 more modular.

In the example shown in FIG. 1, the cells 3 are juxtaposed parallel to one another so that the positive terminal 4 of one cell 3 is positioned facing the negative terminal 4 of the cell or cells juxtaposed next to it. The positive and negative terminals 4 are therefore arranged in a staggered configuration forming two aligned series of terminals 4 and the connection means 6 are positioned on the lateral edges of the connection plate 20 so as to connect said terminals 4 of opposite pole.

In the example shown in FIG. 2, the cells 3 are juxtaposed parallel to one another with the terminals 4 of like pole positioned on one and the same side of the battery module 1. In order to connect the terminals 4 of opposite pole the connection means 6 cross the connection plate 20 widthwise.

The thermal management and connection device also comprises one or more electronic devices (not depicted) for controlling the cells 3, these being placed on the connection plate 20, and more specifically connected to the connection traces 60. These electronic devices provide management and control of physical and electrical parameters of the battery module 1, such as the temperature and voltage thereof. Being placed on the connection plate 20, the electronic device(s) may manage and control the battery module 1 overall or alternatively provide management and control of the cells 3 independently. Thus it is possible to monitor each cell 3 that makes up the battery module 1, individually.

In order to regulate the temperature of the battery module 1, the thermal management and connection device is connected to a thermal management device comprising a heat-exchange plate 10 placed between the aligned series of terminals 4, as FIGS. 1 and 2 show. The heat-exchange plate 10, generally made of metal, contains within it a heat-transfer fluid circuit and allows exchange of heat energy between the battery module 1 and an external thermal management circuit. The heat exchange plate 10 thus comprises an inlet 12a and an outlet 12b for heat-transfer fluid, these being connected to the external thermal management circuit. The heat-transfer fluid inlet 12a and outlet 12b may be positioned on one and the same side of the heat-exchange plate 10 to make fitting and connection easier.

Positioning the heat-exchange plate 10 between the aligned series of terminals 4 allows thermal management of the battery module 1 at the place where such management is needed because, when said battery module 1 is in use, the region where the greatest amount of heat is produced is the region between the terminals 4, because of the electrochemical reactions within the cell 3. In addition, a strong current passes through the connection means 6 and the resistance of the connection means 6 to the passage of this current also causes heat to be produced, which heat production can thus be regulated by the presence of the heat-exchange plate 10.

The connection plate 20 allows electrical insulation between the heat-exchange plate 10 and the connection means 6 of the battery module 1. Specifically, because these elements are made of metal, they are electrical conductors and, were they in contact, that would cause short circuits and would be dangerous. The connection plate 20 additionally, because of the fixing elements 8, allows uniform pressure to be applied to the battery module 1.

According to a first embodiment depicted in FIGS. 1 and 2, the heat-exchange plate 10 is independent of the connection plate 20 and is positioned between the face of the battery module 1 that comprises the terminals 4 and the connection plate 20. To provide electrical insulation, the connection plate 20 may comprise an insulating separating element 24. This insulating separating element 24 may thus be composed of two ribs 24 formed as an integral part of the connection plate 20 and positioned between the terminals 4 and the heat-exchange plate 10.

According to a second embodiment which has not been depicted, the heat-exchange plate 10 is incorporated directly into the connection plate 20.

The connection means 6 perform a dual function because in addition to allowing electricity to be conducted between the terminals 4 of the various cells 3, they allow increased conduction of heat between the heat-exchange plate 10 and the terminals 4. Thus, the thermal regulation performed by the heat-exchange plate 10 is better at said terminals 4, where it is needed.

FIGS. 3 to 6 are schematic depictions in cross section of a battery module 1 in the region of the terminals 4 where the connection means 6 and the connection traces 60 are present. In the various FIGS. 3 to 6, the cells 3 are juxtaposed with their terminals 4 staggered.

FIG. 3 shows a first embodiment of connection means 6 in which these means are placed on the external surface of the connection plate 20, namely on the opposite surface to the surface facing the battery module 1. This embodiment allows ease of fitting of the connection means 6 on the connection plate 20.

FIG. 4 shows a second embodiment of the connection means 6 in which the latter are produced integrally with the conducting traces 60, namely so as to form a single component. The conducting traces 60 thus have an increased thickness in order to improve their thermal conduction and be able to withstand the voltage across the terminals 4. This embodiment notably makes it possible to reduce production costs by limiting the number of steps involved in manufacturing the connection plate 20.

FIG. 5 shows a third embodiment of the connection means 6 in which the latter are placed within the thickness of the connection plate 20, although with a thickness smaller than the thickness of said connection plate 20. This embodiment notably makes it possible to reduce the thickness of the connection plate 20 and to increase the protection of the connection means 6 because the latter are protected in the connection plate 20.

Finally, FIG. 6 shows a last embodiment of the connection means 6 in which the latter are also placed within the thickness of the connection plate 20. In this embodiment, the connection means 6 have a thickness greater than or equal to the thickness of the connection plate 20. This embodiment also allows good protection of the connection means 6 and ease of fitting of said connection means 6, in the form of an insert, on the connection plate 20.

Thus it may be clearly seen that the thermal management and connection device according to the invention, because the connection plate 20 is a printed circuit notably comprising electronic control devices and heat conductors, allows the control and management of the battery module 1 overall, and also of the cells 3 individually to be optimized. In addition, incorporating these various elements onto one and the same device allows for greater compactness and even weight saving of the battery module 1. It also allows for greater modularity in installing the various battery modules 1 within the vehicle. Specifically, because each battery module 1 has its own thermal management and connection device, it is easier to position it as required, in the recesses and volumes available in the vehicle.

1. A thermal management and connection device for a battery module (1) comprising cells (3) which are juxtaposed in parallel and connected in series with one another, each cell (3) comprising a positive terminal (4) and a negative terminal (4), the battery module (1) further comprising a heat-exchange plate (10) comprising an inlet (12a) and an outlet (12b) for heat-transfer fluid, these being positioned between the terminals (4), and a non-conducting connection plate (20) comprising passage orifices (22) for the terminals (4), and means (6) of connecting the terminals (4) together in pairs, wherein the connection plate (20) is a printed circuit comprising conducting traces (60).

2. The thermal management and connection device as claimed in claim 1, wherein the connection plate (20) further comprises electronic devices for controlling the cells (3), the electronic devices being connected to the conducting traces (60).

3. The thermal management and connection device as claimed in claim 1, wherein the connection means (6) of connecting the terminals (4) are positioned in such a way as to allow the terminals (4) to be connected when the cells (3) are juxtaposed with the terminals (4) of an identical pole which are arranged on one and the same side of the battery module (1).

4. The thermal management and connection device as claimed in claim 1, wherein the connection means (6) of connecting the terminals (4) are positioned so as to allow the terminals (4) to be connected when the cells (3) are juxtaposed with the terminals (4) of a different pole which are arranged in a staggered configuration on the battery module (1).

5. The thermal management and connection device as claimed in claim 1, wherein the connection means (6) are positioned on the external surface of the connection plate (20), which is the surface of the connection plate (20) that is the opposite surface to the surface facing the battery module (1).

6. The thermal management and connection device as claimed in claim 1, wherein the connection means (6) are produced integrally with the conducting traces (60), of increased thickness, of the connection plate (20).

7. The thermal management and connection device as claimed in claim 1, wherein the connection means (6) are positioned within the thickness of the connection plate (20).

8. The thermal management and connection device as claimed in claim 1, wherein the connection means (6) have a thickness less than the thickness of the connection plate (20).

9. The thermal management and connection device as claimed in claim 7, wherein the connection means (6) have a thickness equal to or greater than the connection plate (20).

10. The thermal management and connection device as claimed in claim 1, wherein the connection plate (20) is made of a rigid material.

11. The thermal management and connection device as claimed in claim 1, wherein the connection plate (20) is made of a flexible material.

12. The thermal management and connection device as claimed in claim 1, wherein the heat-exchange plate (10) is independent of the connection plate (20).

13. The thermal management and connection device as claimed in claim 1, wherein the heat-exchange plate (10) is incorporated directly into the connection plate (20).

14. The thermal management and connection device as claimed in claim 1, wherein the connection plate (20) comprises separating ribs (24) electrically insulating the heat-exchange plate (10) and the connection means (6).

15. The thermal management and connection device as claimed in claim 2, wherein the connection means (6) of connecting the terminals (4) are positioned in such a way as to allow the terminals (4) to be connected when the cells (3) are juxtaposed with the terminals (4) of an identical pole which are arranged on one and the same side of the battery module (1).

16. The thermal management and connection device as claimed in claim 2, wherein the connection means (6) of connecting the terminals (4) are positioned so as to allow the terminals (4) to be connected when the cells (3) are juxtaposed with the terminals (4) of a different pole which are arranged in a staggered configuration on the battery module (1).
